(19) United States
(12) Patent Application Publication
(10) Pub. No.: US 2009/0159722 A1
(43) Pub. Date: Jun. 25, 2009

(54) Spraying Apparatus, Method for Production Thereof and Use Thereof

(76) Inventors: Peter Tuerk, Baldham (DE); Bernd Hoefler, Augsburg (DE)

Correspondence Address: FLYNN THIEL BOUTELL & TANIS, P.C., 2026 RAMBLING ROAD, KALAMAZOO, MI, 49008-1631, US

(21) Appl. No.: 11/989,116

(22) PCT Filed: Jul. 13, 2006
(86) PCT No.: PCT/EP2006/006835

§ 371 Date: Feb. 27, 2009

(30) Foreign Application Priority Data
Jul. 20, 2005 (DE) 10 2005 033 838.0
May 3, 2006 (DE) 10 2006 020 551.0

(51) Int. Cl. B05B 11/04; B29C 45/00

(52) U.S. Cl. 239/327; 264/328.1; 239/328

(57) ABSTRACT

A spraying apparatus has a container made of silicone gum for receiving the fluid to be sprayed and a shut-off device (3) on the opening (20) of the container. The silicone gum container (2) is closed at the end (2″) facing away from its opening (20) by injection molding of the container (2).

This invention relates to an apparatus for spraying a fluid according to the preamble of claim 1. It also relates to a method for production of the apparatus and to the use thereof.

To avoid propellants in sprays for reasons of environmental protection, it is known to use within the spray can an inner container made of rubber-elastic material which is filled with the liquid to be sprayed and thereby expands. Due to the elasticity of the rubber, the content of the container is subjected to a pressure which leads to atomization of the spraying liquid upon actuation of the valve connected to the inner container. The rubber-elastic material proposed is, among other things, silicone gum, which reversibly contracts to such an extent that only a small residual amount of liquid remains within the inner container.

Thus, EP 0 361 091 A1 discloses an inner container comprising a silicone gum inner layer and an outer layer made of natural rubber, and WO 2005/012136 A 1 an inner container comprising a silicone gum tube whose end facing away from the inner container opening is sealed by being bent. The bent end cannot be reliably sealed, however. The known spraying apparatus is thus useless.

It is the object of the invention to provide a spraying apparatus that fulfills all requirements with regard to pressure, small residual filling amount and tightness.

This is achieved according to the invention by the spraying apparatus characterized in claim 1. Advantageous embodiments of the inventive spraying apparatus are stated in claims 2 to 10. Claim 11 relates to an advantageous method for producing the inventive apparatus, which is advantageously refined by claims 12 to 15. Claim 16 relates to a preferred use of the apparatus.

In the inventive apparatus, the silicone gum container has at its end facing away from the container opening a closed end formed by injection molding of the container. The container is thus configured completely tight at this end as well.

The inventive apparatus is suitable for spraying any fluids, i.e. for liquids but also as a dispenser for gel- and cream-like or pasty or powdered fillers or gases, for example in the household, pharmaceutics, cosmetics, chemistry and of foods.

The shut-off device provided on the container opening is preferably a valve, but can also be a cock, a slide or the like. The actuation of the shut-off device can be effected in different ways. A valve can thus be actuatable e.g. by a pushbutton or a hand lever.

Due to the elasticity of the silicone gum, the content of the filled container is subjected to the necessary pressure for spraying the corresponding amount of spraying liquid upon actuation of the shut-off device. To produce a sufficient pressure for atomization, the silicone gum container preferably has a wall thickness of 2 mm to 8 mm, in particular 3 mm to 6 mm, and a Shore hardness of 10 to 100, preferably 30 to 60, in particular 40 to 60.

Through the Shore hardness and the wall thickness it is also possible to adjust the pressure at which the spraying liquid or other fluid leaves the shut-off device. Thus, a higher Shore hardness will be used e.g. for an insecticide spray, while a lower Shore hardness will be used e.g. for a wound spray.

The silicone rubber or silicone gum container can have any shape. However, it is preferably of tubular design in the empty state, its length being for example 5 cm to 20 cm. The container can possess another shape in the filled state, however, being e.g. spherical. A spherical shape is advantageous in particular in the case of large containers which can be used for example for humidifying air. Such a container can be filled e.g. with 5 liters of water and more.

In the empty state the container has only a small outside diameter of preferably 5 mm to 30 mm, in particular 10 mm to 18 mm. That is, at a wall thickness of for example 5 mm and an outside diameter of for example 12 mm, the inside diameter is only 2 mm, so that only a small residual amount remains in the container, in consideration of the fact that the container can be stretched to 5 times, optionally also to 8 and more times, its outside diameter upon filling. The residual amount can be reduced further by incorporating a preferably rod-shaped displacement body into the container.

To prevent the formation of unwanted bulges through slight fluctuations in the wall thickness upon filling of the container, the container preferably has a wall thickness that decreases gradually from the container opening to the closed end of the container. The decrease of wall thickness can be altogether for example 5% to 30%.

The silicone gum container can be connected directly to the shut-off device. e.g. to a valve. If a valve is used as has been used for many years in customary spray cans available on the market, however, the container is preferably connected to the valve by an adapter. The adapter is preferably constituted by a pipe section which can be connected to the silicone gum container e.g. by high frequency welding, in particular ultrasonic welding, or by insert molding, as explained more precisely hereinafter. The pipe section can be provided for this purpose with ring ribs whose edges are pressed into the silicone gum to strengthen the connection.

The adapter can be fastened to the valve in any manner. In particular if the valve is made of the same or a similar plastic as the adapter, at least in the area where it is connected to the adapter, adapter and valve can be e.g. thermo-welded. The adapter can thus be made e.g. of polyamide and the valve of the same material, at least in the area where it is connected to the adapter. The adapter can also be bonded to the valve, or be configured to snap into or screw into the valve, or the like.

The inventive apparatus can comprise only the silicone gum container and the valve as sell as optionally the adapter, whereby the e.g. tubularly configured silicone gum container can be grasped directly by the hand upon use of the inventive apparatus.

However, the silicone gum container can instead also be disposed within an outer container. The outer container can be e.g. a carton, optionally also a bottle, e.g. with a rotary closure which can be fastened to the valve. Due to its small outside diameter in the empty state also at its end facing away from the container opening, the container can be inserted into a bottle even through a narrow bottle opening. The bottle can be transparent, e.g. a glass bottle, to permit the state of the inner container to be visually checked. It can e.g. also be a plastic bottle.

However, the outer container used is in particular a can which can correspond to a conventional spray can. If a valve customary in the trade for spray cans is then also used, the inventive apparatus can be configured as a spray can very economically.

For producing the silicone gum container of the inventive apparatus it is preferable to use an injection molding die having an outer mold and a core, the silicone gum material being injected into the cavity between outer mold and core. The silicone gum material is preferably injected via a nozzle in the outer mold which is provided in the end of the cavity facing away from the container opening, so that the closed end of the container is formed in the area of the injection molding die facing the nozzle.

It is preferable to insert the adapter into the injection molding die at the end of the cavity facing away from the nozzle upon injection molding of the silicone gum container to connect it firmly to the silicone gum container. The adapter can be placed in the injection molding die for injection molding the silicone gum container immediately after the former has been injection molded e.g. from polyamide, i.e. while still hot. This results in a particularly intimate bond between silicone gum container and adapter.

It is also possible to use a combined injection molding die in which the adapter is first injection molded and then the silicone gum container and connected to the adapter.

The core for injection molding the silicone gum container can be inserted for positioning into the cavity within the pipe-shaped adapter in the injection molding die. The core preferably consists of a bending-resistant material, for example ceramics, or a bending-resistant metal material, optionally also of a metal pipe wherein the end protruding into the cavity is sealed to exactly maintain the given wall thickness of the silicone gum container.

When the wall thickness of the silicone gum container decreases from its opening to its closed end according to claim 7, the core can be configured to be appropriately tapered.

When the silicone gum container has been injection molded, the outer mold is opened, the silicone gum container with the adapter injection-molded thereto removed, and the core pulled out of the adapter. The operations described hereinabove for producing the silicone gum container can of course also be carried out automatically. The core can optionally also remain within the container as a lost core in order to form a displacement rod.

The inventive apparatus is suitable for example for spraying water and oxygen. Particularly the elderly suffer from the summer heat. These people can be offered relief by being provided with the inventive apparatus for spraying water and oxygen. The water can then be sprayed as a fine mist into the face or onto the arms for example. Due to the resulting evaporation cooling it acts as a coolant. The atomized water also counteracts dehydration of the mucous membranes of mouth and nose. The directly supplied oxygen acts additionally as an invigorating shower.

At the same time, the silicone gum container e.g. in a spray can may be filled with water onto which oxygen has been pressed. It is also possible to fill the water into the silicone gum container, and the oxygen into the space between the silicone gum container and the can. It is then possible to spray the water together with the oxygen, or the water and the oxygen separately, with two separate valves or one multiway valve.

The silicone gum material used for injection molding the container of the inventive apparatus can be a solid rubber or a liquid rubber, for example an “Elastosil” rubber from the company Wacker-Chemie AG.

The discharge of the fluid is thus effected with the inventive apparatus uniformly through the restoring force of the inflated silicone gum container. The content is sprayable in every direction, i.e. also upside down. Using a multiple valve system there is the possibility of connecting a plurality of silicone gum containers in series, bringing them together into one valve and spraying as a composition, e.g. a two-component adhesive.

The filling level of the container can be recognized from the shaping of the container. It is possible to discharge a certain amount which can be defined at a marking on the tube. A certain mixture ratio can be exactly obtained particularly for two-component mixtures.

Hereinafter the invention will be explained in more detail by way of example with reference to the enclosed drawing. Therein are shown:

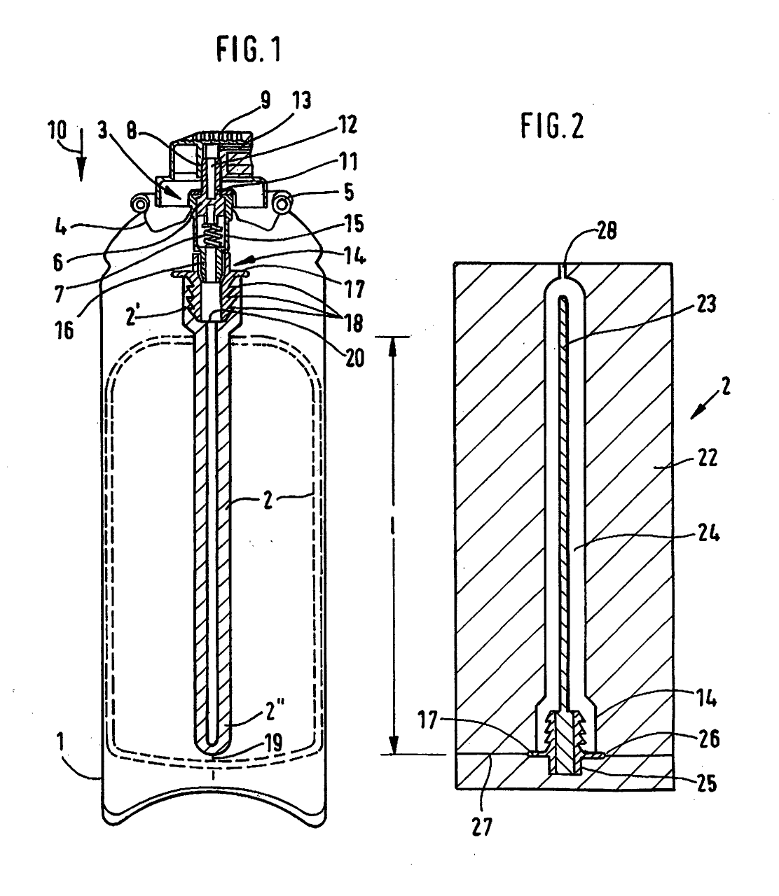

FIG. 1 a longitudinal section through an embodiment of the inventive apparatus; and

FIG. 2 a longitudinal section through an injection molding die for producing the silicone gum container of the inventive apparatus.

According to FIG. 1, the apparatus has as the outer container 1 a can with a valve 3. The can 1 has disposed therein a silicone gum container 2 which is shown by hatching in the empty state and by dashed lines in the filled state.

The valve 3 is fastened to a disk 4 which is flanged at 5 around the edge on the opening of the can 1. The valve 3 comprises the valve body 6 which is loaded in the closed position by a compression spring 7. The valve body 6 has a stem 8 on which a pushbutton 9 is guided, the stem 8 and thus the valve body 6 pushing the valve body 6 into the open position upon pressing of the pushbutton 9 according to the arrow 10 in the direction of the can 1, thereby causing the fluid (not shown in the drawing) in the filled container 2 shown by dashed lines to pass through a cross bore 11 and the longitudinal bore 12 in the stem 8 to the outlet bore 13 in the pushbutton 9 and be sprayed.

The silicone gum container 2 is connected to the valve housing 15 via a pipe-shaped adapter 14, for example by welding to the hollow pin 16 on the valve housing 15 which protrudes into the adapter 14.

The silicone gum container 2 is molded at its opening 20 with its end portion 2′ onto the adapter 14. To strengthen the connection of the end portion 2′ to the adapter 14, the adapter 14 has a disk 17 and, on the side facing the container 2, ring ribs 18 of barb-shaped cross section which engage the silicone gum. Number 19 marks the sprue arising upon injection molding of the silicone gum container 2 at its closed end 2″.

The wall thickness w of the container 2 in the empty state can be e.g. 5 mm, the inflatable length l of the empty container 2 e.g. 150 mm. The outside diameter d of the empty container 2 can be e.g. 12 mm. Over the length l the wall thickness w of the container 2 can decrease from the adapter 14 to the closed end 2″.

According to FIG. 2, the silicone gum container 2 connected to the adapter 14 is produced using an injection molding die 21 comprising an outer mold 22 and a core 23, there being formed between the outer mold 22 and the core 23 a cavity 24 which corresponds to the shape of the empty container 2. The adapter 14 is inserted into the injection molding die 21 at one end of the cavity 23.

The core 23 is inserted for positioning within the cavity 24 at one end into the pipe-shaped adapter 14. The adapter 14 is in turn fixed by engagement with the axial recess 25 in the outer mold 22 and by engagement of its disk 17 with a ring groove 26 in the outer mold 22, the dividing joint 27 of the outer mold 22 extending in the plane of the disk 17. The silicone gum is injected into the mold cavity 24 via the nozzle 28.

1. An apparatus for spraying a fluid having a container (2) made of silicone gum for receiving the fluid and a shut-off device on the container opening (20), characterized in that the silicone gum container (2) has a closed end (2″) facing away from its opening (20) and formed by injection molding of the container (2).

2. The apparatus according to claim 1, characterized in that the silicone gum container (2) has a wall thickness (w) of 2 mm to 8 mm.

3. The apparatus according to claim 1, characterized in that the silicone gum has a Shore hardness of 10 to 100.

4. The apparatus according to claim 1, characterized in that the container (2) is of tubular configuration.

5. The apparatus according to claim 4, characterized in that the container (2) has an outside diameter (d) of 5 mm to 30 mm in the unfilled state.

6. The apparatus according to claim 4, characterized in that the container (2) has a length (1) of 5 cm to 20 cm in the unfilled state.

7. The apparatus according to claim 4, characterized in that the wall thickness (w) of the container (2) decreases from the container opening (20) to the closed end (2″) of the container (2).

8. The apparatus according to claim 1, characterized in that the container opening (20) is connected to the shut-off device via an adapter (14).

9. The apparatus according to claim 8, characterized in that the adapter (14) is of pipe-shaped configuration.

10. The apparatus according to claim 1, characterized in that the silicone gum container (2) is disposed within an outer container (1).

11. A method for producing the apparatus according to claim 1, characterized in that the silicone gum container (2) is injection molded using an injection molding die (21) having an outer mold (22), a core (23) and a cavity (24), corresponding to the shape of the container (2), between outer mold (22) and core (23).

12. The method according to claim 11, characterized in that the silicone gum is injected into the cavity (24) of the injection molding die (21) via a nozzle (28) to form the closed end (2″) of the container (2) within the cavity (24) in the area of the nozzle (28).

13. The method according to claim 11 for producing the apparatus, characterized in that the adapter (14) is inserted into the injection molding die (21) and connected to the silicone gum container (2) upon injection molding.

14. The method according to claim 12, characterized in that the adapter is inserted at the end of the cavity (24) facing away from the nozzle (28).

15. The method according to claim 13, characterized in that the core (23) is positioned within the cavity (24) by the adapter (14).

16. Use of the apparatus according to claim 1 for spraying water and oxygen.
